(19) United States
(12) Patent Application Publication
(10) Pub. No.: US 2016/0110526 A1
(43) Pub. Date: Apr. 21, 2016

(54) SYSTEMS AND METHODS OF SHARING MEDIA CONTENT WITH DIGITAL RIGHTS MANAGEMENT (DRM)

(71) Applicant: Google Inc., Mountain View, CA (US)

(72) Inventors: Andrew Abramson, Sunnyvale, CA (US); Benjamin David Poiesz, Santa Clara, CA (US)

(21) Appl. No.: 14/519,455

(22) Filed: Oct. 21, 2014

(51) Int. Cl. G06F 21/10

(52) U.S. Cl. CPC G06F 21/10; G06Q 2220/18

(57) ABSTRACT

Systems and methods of sharing media content with digital rights management are disclosed that include receiving a media file having media content with a user device, the media content having a first portion and a second portion, when a selection of the provided media content is received by the user device, presenting the first portion of the media content with the user device when the first portion is unencrypted or by decrypting the first portion of the media content with a publically available key with the user device, and presenting the second portion of the media content with the user device when the presentation of the first portion of the media content is complete and when a digital rights management (DRM) key is purchased to decrypt the second portion of the media content.

### BACKGROUND

Content producers have been attempting to increase conversion rates from presenting content previews to a user, such as movie trailer, to the user entering into a transaction to purchase the content (e.g., the full movie). For example, 30 second trailers with major scenes and cliffhangers are typically used in a preview to sell a movie. Although consumers are much more likely to purchase or rent a movie after consuming a longer preview (e.g., the first ten minutes of a movie), there is no presently available way to smoothly transition between the preview and the main movie. To further complicate the situation, the full movie and the preview can have different data protection or Digital Rights Management (DRM) requirements and may need to be downloadable by a consumer to a device or streamed.

### BRIEF SUMMARY

According to an embodiment of the disclosed subject matter, a method is provided that includes receiving a media file having media content with a user device, the media content having a first portion and a second portion, when a selection of the provided media content is received by the user device, presenting the first portion of the media content with the user device when the first portion is unencrypted or by decrypting the first portion of the media content with a publically available key with the user device, and presenting the second portion of the media content with the user device when the presentation of the first portion of the media content is complete and when a digital rights management (DRM) key is purchased to decrypt the second portion of the media content.

According to an embodiment of the disclosed subject matter, an electronic device includes a first communications interface to receive, via at least one of a wireless and a wired communication link, a media file having media content, the media content having a first portion and a second portion, a user input device to receive a selection by a user of the received media content; and a display to present the first portion of the media content when the first portion is unencrypted or to decrypt the first portion of the media content with a processor and a publically available key, and to present the second portion of the media content when the presentation of the first portion of the media content is complete and when a digital rights management (DRM) key is purchased to decrypt the second portion of the media content.

According to an embodiment of the disclosed subject matter, means for sharing media content with digital rights management are provided that include receiving a media file having media content with a user device, the media content having a first portion and a second portion, when a selection of the provided media content is received by the user device, presenting the first portion of the media content with the user device when the first portion is unencrypted or by decrypting the first portion of the media content with a publically available key with the user device, and presenting the second portion of the media content with the user device when the presentation of the first portion of the media content is complete and when a digital rights management (DRM) key is purchased to decrypt the second portion of the media content.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a computing device according to an embodiment of the disclosed subject matter.

FIG. 2 shows a network configuration according to an embodiment of the disclosed subject matter.

FIG. 3 shows an example network and system configuration according to an embodiment of the disclosed subject matter.

FIG. 4 shows an example method of sharing media content with digital rights management according to an embodiment of the disclosed subject matter.

FIG. 5 shows an example media file having media content that is shared according to an embodiment of the disclosed subject matter.

FIGS. 6A-6B show example displays screens that are displayed on a device when presenting the shared media content according to embodiments of the disclosed subject matter.

### DETAILED DESCRIPTION

Embodiments of the presently disclosed subject matter include systems and methods of sharing media content with digital rights management. In the disclosed systems and methods, a media file having media content can be received by a user device. The received media content can include a first portion and a second portion. When a selection of the media content is received by a device, the first portion of the media content can be presented with the user device. The first portion can be unencrypted, or may be decrypted by the user device with a publically available key. The second portion of the media content can be presented by the user device when the presentation of the first portion of the media content is complete and when a digital rights management (DRM) key is purchased to decrypt the second portion of the media content.

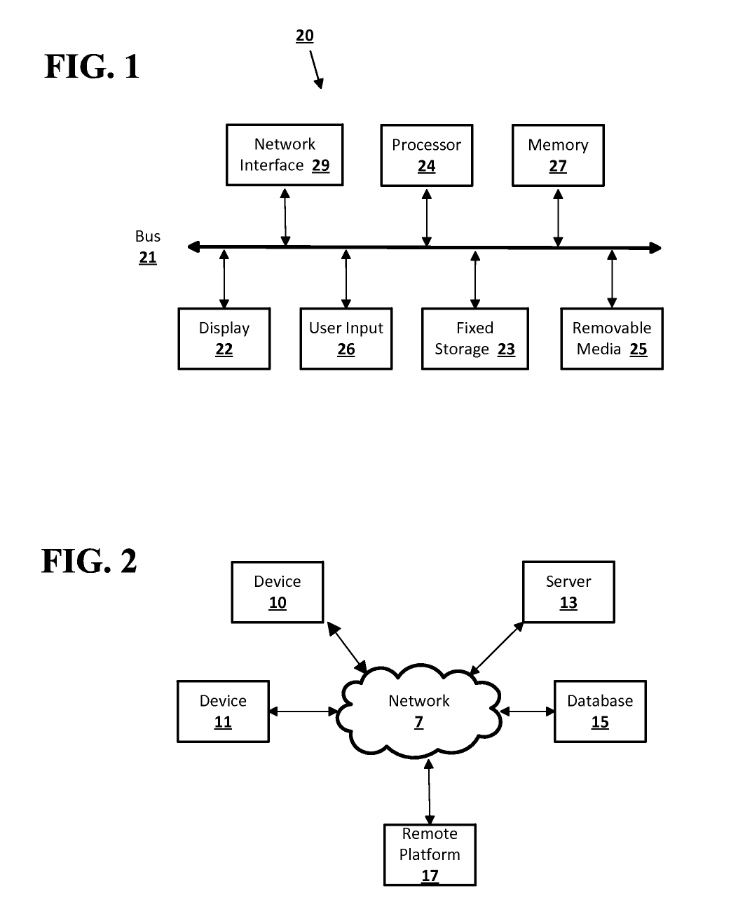

Embodiments of the presently disclosed subject matter may be implemented in and used with a variety of component and network architectures. FIG. 1 is an example computing device 20 suitable for implementing embodiments of the presently disclosed subject matter. The device 20 may be, for example, a desktop or laptop computer, or a mobile computing device such as a smart phone, tablet, or the like. The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth®, near-field, and the like. For example, the network interface 29 may allow the computer to communicate with other computers via one or more local, wide-area, or other communication networks, as described in further detail below.

Many other devices or components (not shown) may be connected in a similar manner (e.g., document scanners, digital cameras, set-top boxes, home media servers, personal media players, gaming consoles, e-book readers, and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an embodiment of the disclosed subject matter. One or more devices 10, 11, such as local computers, smart phones, tablet computing devices, gaming consoles, e-book readers, media players, and the like may connect to other devices via one or more networks 7. Each device (e.g., devices 10 and 11) may be a computing device (e.g., computing device 20) as previously described. The network may be a local network, wide-area network, the Internet, or any other suitable communication network or networks, and may be implemented on any suitable platform including wired and/or wireless networks. The devices may communicate with one or more remote devices, such as servers 13 and/or databases 15. The remote devices may be directly accessible by the devices 10, 11, or one or more other devices may provide intermediary access such as where a server 13 provides access to resources stored in a database 15. The devices 10, 11 also may access remote platforms 17 or services provided by remote platforms 17 such as cloud computing arrangements and services. The remote platform 17 may include one or more servers 13 and/or databases 15.

Devices 10 and 11 may communicate with one another via the one or more networks 7, or may communicate directly with one another via a wired and/or wireless communications link. Media content may be shared between the devices 10 and 11. Alternatively, media content may be shared between devices 10, 11 and at least one of the server 13, the database 15, and the remote platform 17. Links to media content may also be shared between the devices 10 and 11 such that one device may access media content provided by, for example, at least one of the server 13, the database 15, and the remote platform 17.

The media content may include, for example, movies, video content, audio content (e.g., songs, audio books, and the like), text content (e.g., books, magazines, articles, text documents, and the like), and games. The media content may be rented, so as to be available to the user for a predetermined period of time, such as 24 hours, 48 hours, 1 week, or the like.

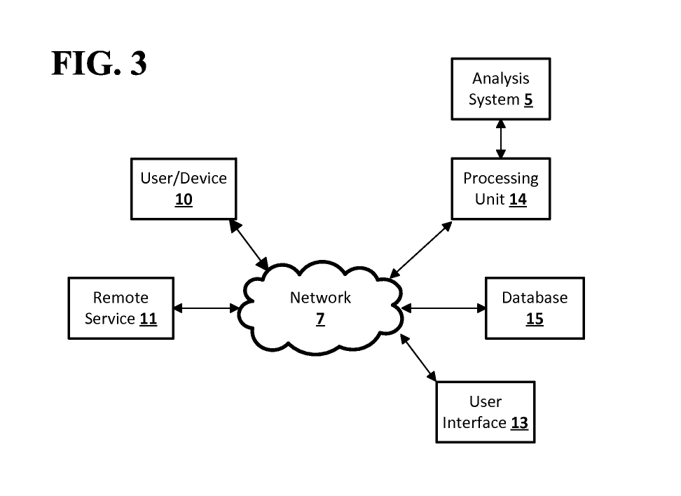

FIG. 3 shows an example arrangement according to an embodiment of the disclosed subject matter. One or more devices or systems 10, 11, such as remote services or service providers 11, user devices 10 such as local computers, smart phones, tablet computing devices, and the like, may connect to other devices via one or more networks 7. The network may be a local network, wide-area network, the Internet, or any other suitable communication network or networks, and may be implemented on any suitable platform including wired and/or wireless networks. The devices 10, 11 may communicate with one or more remote computer systems, such as processing units 14, databases 15, and user interface systems 13. In some cases, the devices 10, 11 may communicate with a user-facing interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to a web browser client on a user device 10, and a computer-readable API or other interface is provided to a remote service client 11.

The user interface 13, database 15, and/or processing units 14 may be part of an integral system, or may include multiple computer systems communicating via a private network, the Internet, or any other suitable network. One or more processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

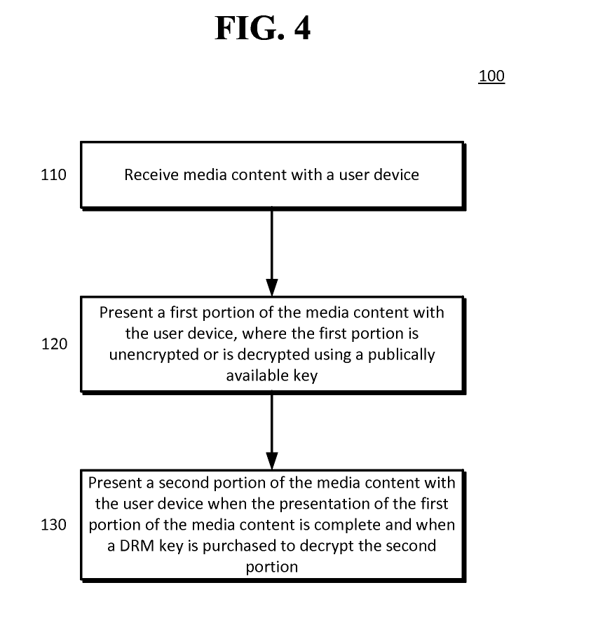

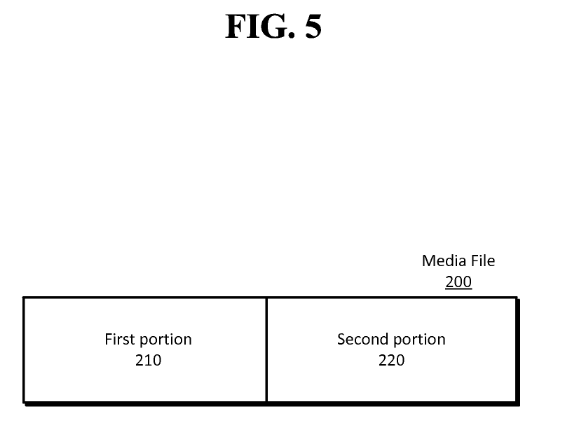

FIG. 4 shows an example method 100 of sharing media content with digital rights management according to an embodiment of the disclosed subject matter. At operation 110, a media file having media content is received with a user device. The media content may include, for example, video content, audio content, text content, game content, and the like. As disclosed in connection with FIG. 5, the media content having a first portion and a second portion. At operation 120, when a selection of the provided media content is received by the user device, the first portion of the media content is presented with the user device. The first portion that is presented can be unencrypted, or can be presented by decrypting the first portion of the media content with a publically available key. At operation 130, the second portion of the media content when the presentation of the first portion of the media content is complete and when a digital rights management (DRM) key is purchased to decrypt the second portion of the media content.

The example method 100 can include receiving, with the user device, a single file having a first file block including the first portion of the media content and a second file block including the second portion of the media content. That is, as illustrated in FIG. 5, the media file 200 can be a single file, where the first portion 210 is a first file block 210 and the second portion 220 is a second file block. When the media file is a single file with a first file block and a second file block, the DRM key to decrypt the second file block can be provided to the user device when the DRM key is purchased.

In an embodiment of the disclosed subject matter, the example method of sharing content may include receiving, with the user device, a media file having a first file with the first portion of the media content, and a second file including the second portion of the media content. As illustrated in FIG. 5, the media file 200 can include separate files, where the first portion 210 is a first file and the second portion 220 is a second file. The second file can be received, for example, when a purchasing selection of the media file has been received with the user device. When purchased, the DRM key can be used by the user device to decrypt the second file.

To minimize delay and to present a seamless experience between the presentation of the first and second portions of the media file having different digital rights management, the example method of disclosed subject matter can receive, with the user device, the second portion of the media content when the first portion of the media content is presented. For example, the second portion of the media content can be received by the user device when the DRM key is purchased, so that the content can be at least partially downloaded and be ready to be presented to the user when the presentation of the first portion is completed.

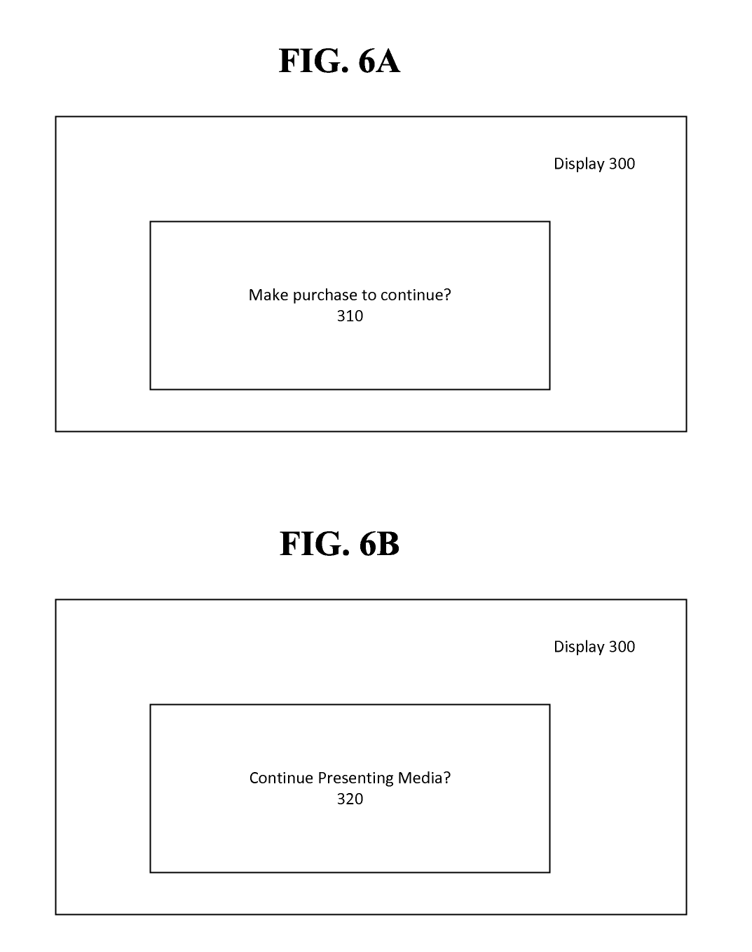

In an embodiment of the disclosed subject matter, the example method of sharing content may provide displaying an option on the user device to purchase the second portion of the media content when the first media content is being presented or when the presentation of the first media content is completed. An example of this displayed option to purchase the media content is described in detail below in connection with FIG. 6A.

In the example method 200 shown in FIG. 4 and disclosed herein, at least the first portion of the media content can be transmitted from the user device to a second device via at least one of a wireless and a wired communications link. In addition to the at least the first portion of the media content, the publically available key can be provided to decrypt the first portion. The media content shared according to the example method 200 may include, for example, video content, audio content, text content, game content, and the like. The presenting of the media content may be by displaying the video content, text content, and game content with a display of the user device and presenting the audio content with at least one speaker of the user device.

In an embodiment of the disclosed subject matter, the purchasing of the DRM key for the second portion of the media content (e.g., in operation 130 disclosed above) may include requesting payment from a user account (e.g., that is associated with the user device) when decrypting the second portion of the media content with the DRM key. The user device may have a setting which authorizes the payment upon the request, or the user device may notify the user via the display of the user device of the request for payment. The purchasing of the DRM key for the second portion of the media content may include requesting payment from a user account when decrypting the second portion of the media content with the DRM key.

In an embodiment of the disclosed subject matter, a payment to a user account may be refunded when decrypting the second portion of the media content with the DRM key has not occurred within a predetermined period of time. For example, if the media content is a movie rental, and the DRM key has not been used to decrypt the second portion of the movie within a predetermined period of time (e.g., 24 hours, 48 hours, 1 week, or the like), the payment for the rental may be refunded to the user account (e.g., the user account associated with the user device).

FIG. 5 shows media file 200, which may include, for example, media content such as movies, video content, audio content (e.g., songs, audio books, and the like), text content (e.g., books, magazines, articles, text documents, and the like), and games. The media file may include a first portion 210 and a second portion 220. For example, the first portion 210 may be a first file that does not include any encryption, digital rights management, or the like. Alternatively, first portion 210 may be a first file that is encrypted with a publically available key. The second portion 220 of the media file 200 may be a second file that is encrypted. For example, when the user purchases the media file 200, the purchase may include a digital rights management (DRM) key that is used by for example, the device 10, 11 to decrypt the second portion 120 to present the content included therein.

In an exemplary embodiment, the media file 200 can be a single file that includes the first portion 210 and the second portion 220. A user of the device (e.g., device 10) may select the media file 200 to be downloaded and/or streamed from the other device (e.g., device 11) or the server 13, database 15, or the remote platform 17. If the media file 200 is stored on the user device, the user may select it so as to begin presenting the media content of the first portion 210 included in the media file at operation 120.

In this exemplary embodiment, the user device may present the first portion 210 of the media file 200 if the first portion 210 is unencrypted. Alternatively, the user device may decrypt the first portion 210 with a publically available key to present the selected media file 200. The publically available key may be provided with the media file 200, for example, in the first portion 210. Alternatively, the user device may retrieve the publically available key from at least one of another device, the server 13, the database 15, and the remote platform 17.

During the presentation of the first portion 210, or when the presentation of the first portion 110 is completed, the user device may display a message 310 in display 300 of FIG. 6A on the display 22 to determine whether the user would like to make a purchase to continue presenting the content of the media file 200. That is, the user device displays the message 310 to prompt the user to provide an input via the user input 26 to select whether to purchase the media file 200. For example, when the media file 200 is a movie, the message 310 may be displayed in display 300 when the first 5 minutes, the first 8 minutes, or the like have elapsed. In another example, when the media file 200 is a game, the message 310 may be displayed in display 300 after the user has played the game for a predetermined period of time (e.g., 5 minutes, 10 minutes, 30 minutes, 1 hour, 5 hours, or the like).

If the user selects to purchase the media file 200, a DRM key can be received by the user device, and the user device can decrypt the second portion 220 of the media file 200. The second portion may be decrypted when the purchase is made so that the content in the second portion may be ready for presentation when the presentation of the first portion 210 is complete.

Alternatively, as illustrated in FIG. 6B, a message 320 of the display 300 may inquire as to whether the user would like to continue with the presentation of the media file 200, if, for example, a purchase of the media file has already been made and the DRM key to decrypt the second portion 220 is accessible. When the user selects to continue with the presentation of the media file 200, the second portion 220 can be decrypted by the device using the DRM key and may be presented when the first portion 210 of the media file 200 has been presented. For example, if the media file 200 is a movie, and the first portion 210 is the first 10 minutes of the movie, when the presentation of the first 10 minutes of the movie is complete, the message 320 may be displayed to inquire as to whether the user wishes to continue with the presentation of the media file 200.

In an exemplary embodiment, the first portion 210 of FIG. 5 is a first file, and the second portion 220 is a second file. As disclosed above, the first file of the first portion 210 may be unencrypted or may be decrypted by the device with the publically available key. When the first file of the first portion 210 is being presented, or when the presentation of the first file of the first portion 210 is completed, the device 10, 11 may present a display 300 including a message 310 to inquire as to whether the user would like to make a purchase so as to continue the presentation of the media file. When the user selects to make the purchase, the second file of the second portion 120 is transmitted to the device from at least one of another device, the server 13, the database 15, or the remote platform 17. The DRM key to decrypt the second file of the second portion 210 may be included with the second file, or may be separately provided from at least one of another device, the server 13, the database 15, or the remote platform 17 when the purchase is selected. With the DRM key, the device can decrypt the second file, and it may be presented when the presentation of the first file 210 is completed.

In an exemplary embodiment, when the user has elected to purchase the media file 100, at least one of the billing and the payment for the media file in a financial transaction may occur when the DRM key is used in the decryption of the second portion 220. A financial account of the user (e.g., that is associated with the user device) may be refunded if the user does not access the media content of the second portion 220 of the media file 200 after a predetermined period of time elapses. For example, if the user does not use the DRM key to decrypt the second portion 220 within, for example, 24 hours, 48 hours, one week, two weeks, one month, or the like, the user's financial account that was used to purchase the media file 200 may be refunded. When the user's account is refunded, the DRM key may be deleted, removed, destroyed, or the like.

Referring to FIG. 5 which shows the media file 200 having the first portion 210 and the second portion 220, these portions may be different according to the types of media files. For example, if the media file 200 is an e-book, the first portion 210 may include a predetermined number of pages, the first chapter of the book, and the like, and the second portion 220 may include the remaining pages, chapters, notes, and the like. If the media file is a music, the first portion 210 may include a portion of a song, a complete song, or portions of one or more songs associated with an album of music. The second portion 220 can include the remaining portions of songs, the remaining songs, the album of songs, and the like. If the media file 200 is, for example, a movie, the first portion 210 can be the first 30 seconds, first five minutes, the first 10 minutes, and the like of the movie, and the second portion 220 may be the remaining portion of the movie. If the media file 200 is a game, the first portion 210 may be a first level of the game, a predetermined amount of time in which the user may play the game without purchase, or the like, and the second portion 220 may include the other levels or portions of the game.

The example embodiments disclosed herein provide systems and method of sharing content having different digital rights management, and which increase the seamlessness of the transition between the presentation of a first portion of media content that may be easily sharable and distributed, and a second portion of media content that can be decrypted when a DRM key is purchased.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location, credit card information, financial account information). In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a system as disclosed herein.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
receiving a media file having media content with a user device, the media content having a first portion and a second portion;
when a selection of the provided media content is received by the user device, presenting the first portion of the media content with the user device when the first portion is unencrypted or by decrypting the first portion of the media content with a publically available key with the user device; and
presenting the second portion of the media content with the user device when the presentation of the first portion of the media content is complete and when a digital rights management (DRM) key is purchased to decrypt the second portion of the media content.

2. The method of claim 1, wherein the receiving the media file with the user device comprises:
receiving, with the user device, a single file having a first file block including the first portion of the media content and a second file block including the second portion of the media content.

3. The method of claim 2, further comprising:
receiving, with the user device, the DRM key to decrypt the second file when the DRM key is purchased.

4. The method of claim 1, wherein the receiving the media file with the user device comprises:
receiving a first file including the first portion of the media content, and receiving a second file including a second portion of the media content.

5. The method of claim 4, wherein the second file is received when a purchasing selection of the media file has been received with the user device.

6. The method of claim 4, further comprising:
receiving, with the user device, the DRM key to decrypt the second file when the DRM key is purchased.

7. The method of claim 1, further comprising:
receiving, with the user device, the second portion of the media content when the first portion of the media content is presented.

8. The method of claim 7, wherein the retrieving comprises:
receiving, with the user device, the second portion of the media content when the DRM key is purchased.

9. The method of claim 1, further comprising:
displaying an option on the user device to purchase the second portion of the media content when the first media content is being presented or when the presentation of the first media content is completed.

10. The method of claim 1, further comprising:
transmitting, from the user device to a second device via at least one of a wireless and a wired communications link, at least the first portion of the media content.

11. The method of claim 10, wherein the transmitting further comprises:
transmitting, from the user device to the second device via at least one of the wireless and the wired communications link, the publically available key.

12. The method of claim 1, wherein the media content comprises at least one video content, audio content, text content, and game content.

13. The method of claim 12, wherein the presenting comprises at least one of displaying the video content, text content, and game content with a display of the user device and presenting the audio content with at least one speaker of the user device.

14. The method of claim 1, wherein the purchasing of the DRM key for the second portion of the media content comprises:
requesting payment from a user account associated with the user device when decrypting the second portion of the media content with the DRM key.

15. The method of claim 1, further comprising:
refunding a payment to a user account associated with the user device when decrypting the second portion of the media content with the DRM key has not occurred within a predetermined period of time.

16. The method of claim 1, wherein the purchasing of the DRM key for the second portion of the media content comprises:
requesting payment from a user account associated with the user device when decrypting the second portion of the media content with the DRM key.

17. An electronic device comprising:
a first communications interface to receive, via at least one of a wireless and a wired communication link, a media file having media content, the media content having a first portion and a second portion;
a user input device to receive a selection by a user of the received media content; and
a display to present the first portion of the media content when the first portion is unencrypted or to decrypt the first portion of the media content with a processor and a publically available key, and to present the second portion of the media content when the presentation of the first portion of the media content is complete and when a digital rights management (DRM) key is purchased to decrypt the second portion of the media content.

18. The electronic device of claim 17, wherein the media file received via the communications link comprises a single file having a first file block including the first portion of the media content and a second file block including the second portion of the media content.

19. The electronic device of claim 17, wherein the media file received via the communications link comprises a first file including the first portion of the media content, and a second file including a second portion of the media content.

20. The electronic device of claim 17, wherein the display of the electronic device displays a selectable option for a user to purchase the second portion of the media content when the first media content is being presented or when the presentation of the first media content is completed.
